(19) United States
(12) Patent Application Publication
(10) Pub. No.: US 2014/0000175 A1
(43) Pub. Date: Jan. 2, 2014

(54) VEHICLE COMPRISING A LOCK FOR LOCKING AN OPENING PANEL

(71) Applicant: Guillaume Lesueur, Creteil (FR)

(72) Inventor: Guillaume Lesueur, Creteil (FR)

(73) Assignee: VALEO SECURITE HABITACLE, Creteil (FR)

(21) Appl. No.: 13/823,748

(22) PCT Filed: Sep. 16, 2011
(86) PCT No.: PCT/EP11/66072

§ 371 Date: Sep. 16, 2013

(30) Foreign Application Priority Data
Sep. 16, 2010 (FR) 10/03684

(51) Int. Cl. E05B 65/06; E05B 17/14; B60R 1/12

(52) U.S. Cl. CPC E05B 65/06; B60R 1/12; E05B 17/14
USPC 49/503; 29/428

(57) ABSTRACT

The vehicle comprises:—at least one opening panel (6),—at least one rear-view mirror (10), and—a lock (14) for locking the opening panel, the lock being able to be contiguous with the rear-view mirror and preferably being contiguous therewith.

The invention relates to locks for a vehicle opening panel.

Increasingly, vehicles are provided with remote control or hands-free systems for locking opening panels. In such a case, it is not necessary to use the lock of one of the doors in order to lock or unlock the vehicle. However, there is provided on the vehicle a lock which is used as an emergency lock if the remote control or the hands-free system or the battery on which it is dependent is out of use. Opening panel handles are elements which have a substantial effect on the style of the vehicle and which themselves form a style element. In order to prevent any influence on the style with the door lock, the lock is often concealed by the handle. It thus has a cover without an orifice or is hidden behind a movable portion of the handle. However, in some cases, the latter solutions have been found to be compatible with the style desired for the vehicle only with difficulty.

An object of the invention is to lift to the greatest possible extent the restrictions associated with the lock which impair the style of the vehicle.

To this end, there is provided according to the invention a vehicle which comprises:

at least one opening panel,

at least one rear view mirror, and

a lock for locking the opening panel, the lock being capable of being contiguous with the rear view mirror and preferably being contiguous therewith.

In this manner, by associating the lock with the rear view mirror, the handle is liberated from any restriction relating to the presence of the lock. It is therefore much easier to give the handle the desired style. More generally, the majority of the outer face of the opening panel is what is liberated from the presence of the lock. The lock is visually embedded in the assembly formed by the rear view mirror and is relatively imperceptible to the eye so that it has little influence on the style of the vehicle.

Advantageously, the lock is accessible through an opening of the rear view mirror.

Advantageously, the vehicle comprises a closure member which is capable of covering the opening.

The lock is thus hidden from view.

Preferably, since the rear view mirror comprises a support which connects the rear view mirror to the vehicle, the lock is contiguous with the support.

Advantageously, the rear view mirror comprises a support and a tilting portion which is movably mounted relative to the support between an operational position in which it covers the lock and an inactive position in which it leaves the lock uncovered.

In this manner, the lock is completely invisible when the rear view mirror is in an operational position. Consequently, it has no influence at all on the style of the vehicle.

In one embodiment, the lock and the rear view mirror are rigidly fixed to the opening panel.

In another embodiment, the lock and the rear view mirror are rigidly fixed to a bodywork of the vehicle.

It is possible to make provision for the lock to comprise a stator, a rotor and lugs which are capable of allowing or preventing a rotation of the rotor relative to the stator.

There is also provided according to the invention a vehicle assembly which comprises:

a lock for locking an opening panel, and

a rear view mirror which has an opening for access to the lock.

Such an assembly serves to produce the above-mentioned vehicle according to the invention.

Finally, there is provided according to the invention a method for producing a vehicle in which:

a lock for locking an opening panel is installed on a frame of the opening panel, in particular from a face of the opening panel which is exterior with respect to the vehicle,

the lock is fixed to the frame from a face of the opening panel which is interior with respect to the vehicle, and

a rear view mirror is installed on the frame so that the lock is capable of being contiguous with the rear view mirror.

Other features and advantages of the invention will be further appreciated from the following description of an embodiment which is given by way of non-limiting example with reference to the appended drawings, in which:

FIG. 1 is a schematic plan view of a vehicle according to the invention;

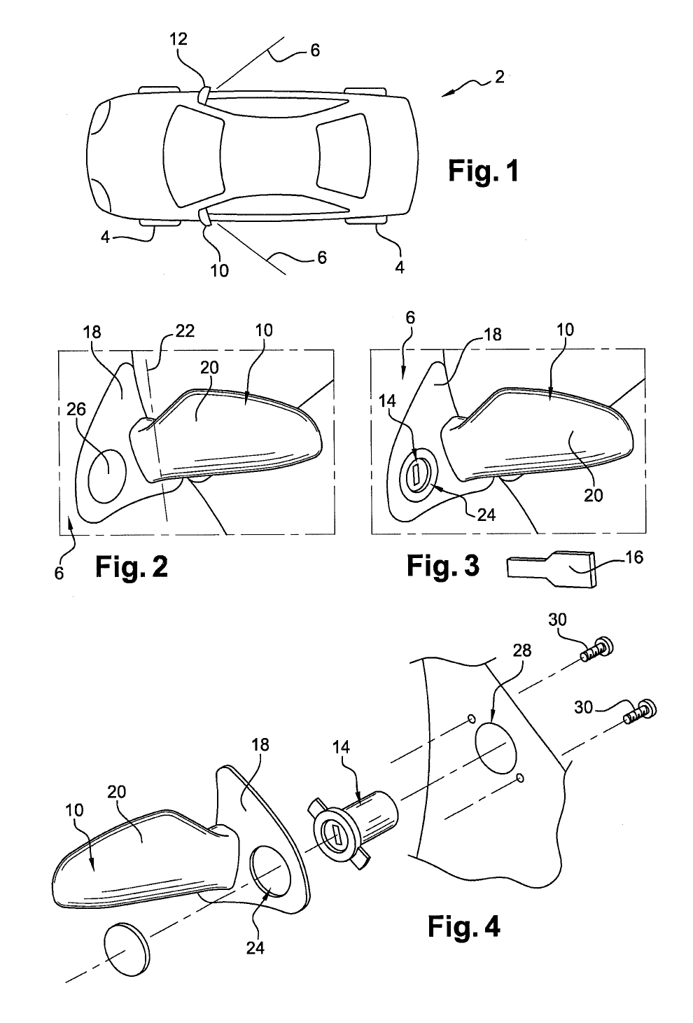

FIGS. 2 and 3 are two perspective views of the front left rear view mirror of the vehicle of FIG. 1, with the lock covered and uncovered by the cover, respectively;

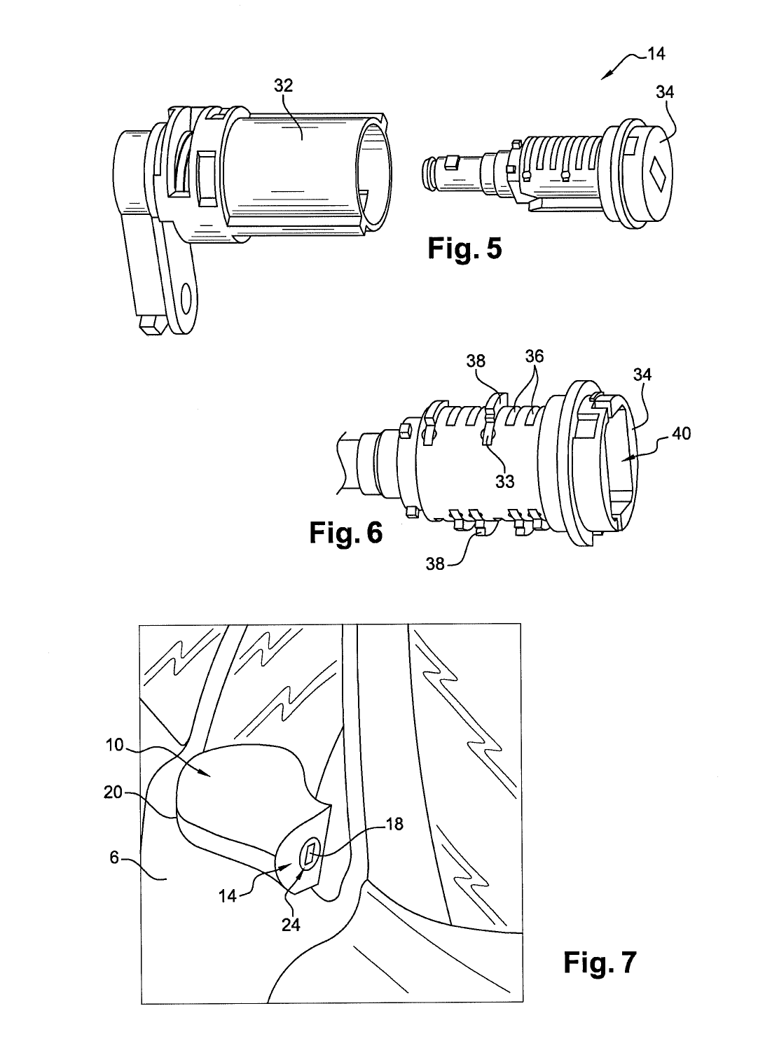

FIG. 4 is an exploded view of the rear view mirror and the lock of FIG. 2 illustrating the assembly thereof;

FIG. 5 is a view of the stator and rotor of the lock of FIG. 4;

FIG. 6 is a view of the rotor of the lock of FIG. 4; and

FIG. 7 is a view similar to FIG. 2 illustrating a second embodiment.

FIGS. 1 to 6 illustrate a first embodiment of a motor vehicle 2 according to the invention. The vehicle comprises in this instance four wheels 4 and opening panels 6 which are formed in this instance by front left and front right doors. However, it may further comprise a rear left door and a rear right door and a rear tailgate. The vehicle comprises two rear view mirrors, a left rear view mirror 10 and a right rear view mirror 12, respectively, which are located at the driver side and passenger side, respectively.

Each opening panel 6 comprises a handle which allows the opening panel to be unblocked when it is in a closed position on the bodywork, in order to open it. For this purpose, each opening panel comprises in this instance an outer handle and an inner handle which are accessible from the outer side and the inner side of the vehicle, respectively.

The vehicle comprises at least one lock 14 which is capable of having a locked configuration in which it prevents the opening of one of the opening panels under the action of one of the handles thereof being operated, and an unlocked position in which it authorizes the opening of the opening panel using these handles. The changing of the lock from one configuration to the other is carried out using an external element, such as an insert, for example, in the form of a key 16 which the user inserts into the outer end face of the lock.

In the present example, the rear view mirror 10 comprises a support 18 and a tilting portion 20 which comprises a mirror which is not illustrated. The mirror is mounted therein so that its position relative thereto can be adjusted. The support 18 connects the rear view mirror 10 to the opening panel 6 and in particular connects the tilting portion 20 to the opening panel. The tilting portion 20 is mounted so as to be movable in rotation about a vertical axis 22 relative to the support 18. In this manner, it can be moved between an operational position illustrated in FIG. 2 in which it allows the driver to observe the side of the vehicle and an inactive position tilted in the direction towards the inner side of the vehicle.

The lock 14 is contiguous with the support 18. In the present example, it has a through-opening 24 which is provided in the wall of the support. This opening is circular and extends in a substantially vertical plane parallel with the general plane of the opening panel. The lock 14 is fixed to the frame 6 so that the external end thereof is contiguous with this opening 24 and is thus made accessible from the outer side of the vehicle for the introduction of the key 16 into the opening and the locking or unlocking of the lock. The vehicle further comprises a removable or retractable cover 26 which allows the opening 24 to be covered in order to conceal the lock 14 from view. The cover 26 is, for example, clipped to the support 18 in order to be fixed in position there.

In order to fix the rear view mirror and the lock to the opening panel, it is possible to use the following method.

The lock 14 is introduced into a housing 28 which is provided for this purpose in the frame of the opening panel. This introduction takes place in this instance from the outer side of the vehicle and from the face of the opening panel located at the outer side of the vehicle when the opening panel is locked.

The lock 14 is then fixed to the opening panel in a rigid manner using one or more fixing elements, such as screws 30. The screws are positioned from the face of the opening panel located towards the inner side of the vehicle for reasons of security because the risks of malicious disassembly of the lock from the outer side of the vehicle are thereby reduced.

Finally, the rear view mirror 10 is installed with its support 18 and its tilting portion 20 from the outer side of the opening panel thereon by placing the opening 24 opposite the housing 28 which receives the lock 14.

The lock 14 may be of conventional type. With reference to FIGS. 5 and 6, it may, for example, comprise a stator 32 which receives a rotor or barrel 34 which is rotatably mounted relative to the stator about a longitudinal axis thereof, which is horizontal in this instance. The rotor 34 has transverse housings 36 in which respective movable elements, such as lugs 38, are received. When the lock is in the unlocked configuration thereof, the lugs do not extend beyond the contours of the rotor and thus allow it to rotate relative to the stator. In the reverse case, which has been illustrated in FIG. 6, the lugs protrude out of the rotor and prevent its rotation relative to the stator. The introduction of the key 16 into the opening 40 of the rotor provided for this purpose allows the lugs to be placed in an unlocking position in order to rotate the rotor. For further details regarding such a lock, reference may be made to the application FR-2 882 081. However, locks of a different type may be envisaged.

The lock is used in the following manner.

During conventional use of the vehicle, the lock 14 is covered by the cover 26 and thus remains invisible. The vehicle 2 comprises a remote control or hands-free central locking and unlocking system so that the lock in normal use is not used for locking and unlocking the vehicle. In this instance, it is used only as an emergency lock.

If the remote control of the locking or unlocking system, the hands-free system or a battery which supplies them is out of service, it is possible to use the lock 14 for locking or unlocking. To this end, the user removes the cover 26 and introduces the key 16 into the opening 24 through the support 18 of the rear view mirror. He can thus readily lock the vehicle in order to prevent access thereto or unlock it in order to allow the opening panels to be opened. It is assumed in this instance that the locking of the vehicle is centralized so that the action on the lock 14 brings about the unlocking of all the opening panels of the vehicle. The same applies to the unlocking action.

Another embodiment of the invention is illustrated in FIG. 7. This embodiment is similar to the above embodiment apart from the fact that the opening 24 of the support 18 is positioned so that it is covered by the tilting portion 20 when it is in an operational position. The opening is uncovered only when the mirror carrier is in an inactive position, as illustrated in FIG. 7. In order to access the lock if required, it is therefore sufficient to place the tilting portion 20 in an inactive position.

Of course, it is possible to carry out numerous modifications to the invention without departing from the scope thereof.

The lock 14 could be associated with the door located at the passenger side.

It is possible to make provision for the two front doors of the vehicle to be provided with a lock which is associated with the rear view mirror in question.

It is possible to make provision for the lock to be contiguous with the rear view mirror without appearing in an opening of the support thereof. It may, for example, appear in a notch of the support or simply be contiguous therewith.

It is possible to make provision for the lock to be arranged in such a manner that it is hidden by the rear view mirror when it is in an inactive position and uncovered when the rear view mirror is in an operational position.

It is possible to make provision for the rear view mirror and the lock to be rigidly fixed not to the door, but to the bodywork relative to which the opening panel is movably mounted.

1. A vehicle, comprising:
at least one opening panel;
at least one rear view mirror; and
a lock for locking the opening panel, wherein the lock is contiguous with the rear view mirror.

2. The vehicle as claimed in claim 1, wherein the lock is accessible through an opening of the rear view mirror.

3. The vehicle as claimed in claim 2, further comprising a closure member for covering the opening.

4. The vehicle as claimed in claim 1, wherein the rear view mirror comprises a support which connects the rear view mirror to the vehicle, and wherein the lock is contiguous with the support.

5. The vehicle as claimed in claim 1, wherein the rear view mirror comprises a support and a tilting portion which is movably mounted relative to the support between an operational position in which the tilting portion covers the lock and an inactive position in which the tilting portion leaves the lock uncovered.

6. The vehicle as claimed in claim 1, wherein the lock and the rear view mirror are rigidly fixed to the opening panel.

7. The vehicle as claimed in claim 1, wherein the lock and the rear view mirror are rigidly fixed to a bodywork of the vehicle.

8. The vehicle as claimed in claim 1, wherein the lock comprises a stator, a rotor, and lugs which are capable of allowing or preventing a rotation of the rotor relative to the stator.

9. An assembly for a vehicle, comprising:
a lock for locking an opening panel; and
a rear view mirror which has an opening for access to the lock.

10. A method for manufacturing a vehicle, comprising:
installing a lock for locking an opening panel on a frame of the opening panel, from a face of the opening panel which is exterior with respect to the vehicle;
fixing the lock to the frame from a face of the opening panel which is interior with respect to the vehicle; and
installing a rear view mirror on the frame so that the lock is contiguous with the rear view mirror.
